(19) United States
(12) Patent Application Publication
(10) Pub. No.: US 2020/0306911 A1
(43) Pub. Date: Oct. 1, 2020

(54) POWER TOOL AND DUST COLLECTION SYSTEM FOR POWER TOOL

(71) Applicant: MAKITA CORPORATION, Anjo-shi (JP)

(72) Inventors: Hitoshi IIDA, Anjo-shi (JP); Keita MORI, Anjo-shi (JP)

(73) Assignee: MAKITA CORPORATION, Anjo-shi (JP)

(21) Appl. No.: 16/775,332

(22) Filed: Jan. 29, 2020

(30) Foreign Application Priority Data
Mar. 26, 2019 (JP) 2019-058949

(51) Int. Cl. B23Q 17/00; B25F 5/00; B23Q 11/00; B08B 15/04

(52) U.S. Cl. CPC B23Q 17/007; B25F 5/00; B23Q 2717/00; B23Q 11/0071; B08B 15/04; B23Q 11/0046

(57) ABSTRACT

The dust concentration is prevented from increasing with uncollected dust scattering in a work environment. A dust collection system for a power tool includes a power tool, a dust collection apparatus connected to the power tool, and a system control unit that controls an operation of the system for controlling an operation of the power tool and/or an operation of the dust collection apparatus in accordance with the dust concentration obtained from an external unit.

### CROSS-REFERENCE TO RELATED APPLICATIONS

This application claims the benefit of priority to Japanese Patent Application No. 2019-058949, filed on Mar. 26, 2019, the entire contents of which are hereby incorporated by reference.

### BACKGROUND

### 1. Technical Field

The present invention relates to a power tool and a dust collection system for a power tool.

### 2. Description of the Background

A power tool such as an electric drill or a hammer drill may be used in a dust collection system in which a dust collection apparatus is installed to collect and store dust from a workpiece during machining such as drilling, as one such example is described in Japanese Unexamined Patent Application Publication No. 2018-69397. In such a known dust collection system, a dust collection fan included in the dust collection apparatus is rotated by a dust collection motor to suck air including dust through a suction port at a tip of the tool. The dust then passes through a dust box inside the dust collection apparatus, where it is caught by a filter inside the dust box and stored without scattering.

### BRIEF SUMMARY

In a known dust collection system, a power tool used alone without a dust collection apparatus or with a dust collection apparatus that sucks less dust due to a clogged filter or due to an increased amount of dust may scatter uncollected dust and increase the dust concentration in a work environment (particularly indoors).

One or more aspects of the present invention are directed to a power tool and a dust collection system for a power tool that prevent the dust concentration from increasing with uncollected dust scattering in the work environment.

A first aspect of the present invention provides a power tool, including:

a control unit configured to control an operation, and regulate the operation when a dust concentration obtained from an external unit is greater than or equal to a predetermined threshold.

A second aspect of the present invention provides a dust collection system for a power tool, the system including:

a power tool;

a dust collection apparatus connected to the power tool; and

a system control unit configured to control an operation of the system, and control an operation of the power tool and/or an operation of the dust collection apparatus in accordance with a dust concentration obtained from an external unit.

A third aspect of the present invention provides a dust collection system for a power tool, the system including:

a power tool;

a dust collection apparatus connected to the power tool; and

a system control unit configured to control an operation of the system, and control an operation of the power tool in accordance with a state of the dust collection apparatus.

The power tool and the dust collection system for the power tool according to the aspects of the present invention prevent the dust concentration from increasing with uncollected dust scattering in the work environment.

### BRIEF DESCRIPTION OF DRAWINGS

FIG. 1 is a longitudinal central sectional view of a dust collection system according to a first embodiment.

FIG. 2 is a flowchart of operation control for the dust collection system according to the first embodiment.

FIG. 3 is a flowchart of operation control for a dust collection system according to a second embodiment.

### DETAILED DESCRIPTION

One or more embodiments will now be described with reference to the drawings.

### First Embodiment

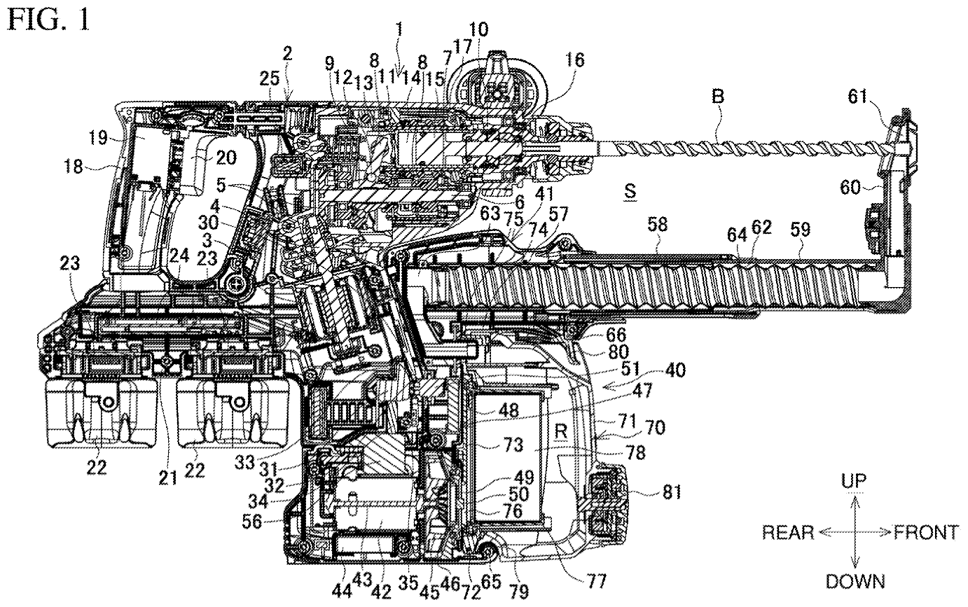

A power tool according to the present embodiment may be a hammer drill 1. FIG. 1 is a longitudinal central sectional view of a dust collection system S including the hammer drill 1 to which a dust collection attachment 40 is attached.

The hammer drill 1 includes a housing 2 and a motor (brushless motor) 3. The housing 2 includes a pair of right and left halves of the housing that are assembled together. The motor 3 is accommodated in a front lower portion of the housing 2 to have an output shaft 4 tilted rearward. A countershaft 6 is supported in the front-rear direction above the motor 3. The countershaft 6 receives a torque transmitted through a bevel gear 5. The countershaft 6 receives a first gear 7, a clutch 8, and a boss sleeve 9 in this order from the front. Above the countershaft 6, a tool holder 10 is axially supported in parallel with the countershaft 6. The tool holder 10 can hold a bit B at its distal end. A piston cylinder 11 is inserted through the rear of the tool holder 10 in a movable manner. The piston cylinder 11 receives an arm 13 connected at its rear end. The boss sleeve 9 externally holds the arm 13 with a swash bearing 12 with the axis tilted. The piston cylinder 11 contains a striker 15 across an air chamber 14 in a reciprocable manner. The striker 15 can strike an impact bolt 16 located in front of the striker 15. The first gear 7 meshes with a second gear 17 attached to the tool holder 10.

A handle 18 is located in a rear upper portion of the housing 2. The handle 18 includes a switch 19 and a switch lever 20. A battery mount 21 is located below the handle 18. The battery mount 21 receives two battery packs 22 aligned in the front-rear direction as a power supply. Each battery pack 22 is slide-attached in the lateral direction. The battery mount 21 internally includes terminal blocks 23. The terminal blocks 23 are electrically connectable to the attached battery packs 22. A controller 24 is accommodated above the terminal blocks 23 to extend in the front-rear direction. The controller 24 is electrically connected to electric components including the motor 3, the switch 19, and the terminal blocks 23. The controller 24 includes a circuit board receiving, for example, a microcomputer and switching elements.

A wireless unit 25 is located on a right side surface of the housing 2 behind the countershaft 6. The wireless unit 25 is electrically connected to the controller 24. The wireless unit 25 can communicate, using a wireless communication technique such as Bluetooth (registered trademark), with an external dust collection device and an external dust concentration meter (not shown) that also have the wireless communication function.

The front lower portion of the housing 2 is an attachment portion 30. The attachment portion 30 has a front surface sloping downward, and protrudes in front of the battery packs 22. The attachment portion 30 receives the dust collection attachment 40. A female connector 31 is located below the motor 3 inside the attachment portion 30. The female connector 31 includes a female terminal for power supply and two female terminals for communication (three female terminals in total) arranged in the lateral direction. An insertion opening 32 is formed in the front surface of the attachment portion 30 in front of the female connector 31. The female connector 31 is supported in a manner swingable about its rear end in the up-down direction. The female connector 31 is urged to the lowermost position by a torsion spring (not shown) to allow an upper shutter 33 to close the insertion opening 32. A pressing bar 34 is located below the female connector 31 in a manner movable upward and downward. The pressing bar 34 protrudes toward the lower surface of the attachment portion 30 at the lowermost position of the female connector 31. A lower recess 35 is located at the lateral center of the lower surface of the attachment portion 30. The lower recess 35 is open frontward and downward. The pressing bar 34 protrudes in the lower recess 35. The two side surfaces of the attachment portion 30 on the right and left of the lower recess 35 each have a guide groove (not shown) extending in the front-rear direction. The guide grooves receive the dust collection attachment 40 in a slidable manner.

The dust collection attachment 40 includes a pair of right and left halves of a casing that are assembled together. The dust collection attachment 40 includes a casing 41. A rear upper portion of the casing 41 is fitted with the attachment portion 30 of the hammer drill 1. A rear lower portion of the casing 41 accommodates a dust collection motor 42. The dust collection motor 42 includes an output shaft 43 facing frontward. A dust collection controller 44 is located below the dust collection motor 42. A dust collection fan 45 is fastened to the output shaft 43. The dust collection fan 45 is accommodated in an air inlet chamber 46. The air inlet chamber 46 is a compartment defined in the casing 41, and has an air outlet (not shown) in its side surface. The casing 41 includes a connecting portion 47 at its front lower surface for a dust box 70. The connecting portion 47 is in front of the air inlet chamber 46 and recedes to have a front opening. A partition 48 behind the connecting portion 47 serving as the bottom of the connecting portion 47 has a communication hole 49. The communication hole 49 is coaxial with the dust collection fan 45, and connects the connecting portion 47 and the air inlet chamber 46. A pressure sensor 50 is located inside the communication hole 49. The pressure sensor 50 detects the pressure of passing air. The pressure sensor 50 is electrically connected to the dust collection controller 44.

A male connector 51 is located on an upper rear surface of the casing 41. The male connector 51 includes three plate-like male terminals for power supply and for communication. The male terminals protrude rearward.

A pair of guide rails (not shown) are located on the right and left on a rear upper surface of the casing 41. The guide rails extend in the front-rear direction, and can be fitted in the guide grooves on the right and left surfaces of the attachment portion 30. The rear upper surface of the casing 41 includes an upward pressing member 56 between the guide rails. The upward pressing member 56 has a rear surface sloping downward. When the attachment portion 30 is fitted, the upward pressing member 56 enters the lower recess 35 and presses the pressing bar 34 upward.

In the casing 41, a guide passage 57 extends above the connecting portion 47 in the front-rear direction. The guide passage 57 has an open front end, and a rear end bent in a U shape to extend behind the connecting portion 47. The guide passage 57 holds a guide cylinder 58 protruding forward. A slide cylinder 59 is internally connected to the guide cylinder 58 in a manner movable in the front-rear direction. A nozzle 60 is connected to the front end of the slide cylinder 59. The nozzle 60 is L-shaped and has a tip upward. The nozzle 60 has a cylindrical suction port 61 in its tip. A bit B coaxially passes through the suction port 61.

The guide passage 57 and the slide cylinder 59 internally accommodate a flexible hose 62. The flexible hose 62 has a front end connected to the nozzle 60, and a rear end connected to a duct 63. The duct 63 is a cylinder bent in a U shape in conformance with the rear end shape of the guide passage 57. A spiral wire 64 is located integrally with the flexible hose 62 to urge the flexible hose 62 in an extension direction. The flexible hose 62 urges the nozzle 60 and the slide cylinder 59 forward. A lower end portion of the duct 63 passes through the partition 48, and protrudes inside the connecting portion 47. A receiving shaft 65 protrudes laterally at the lower end of the connecting portion 47 and in front of the partition 48. An engagement protrusion 66 is located at a frontward position on an upper inner surface of the connecting portion 47. The engagement protrusion 66 engages with an upper side of the dust box 70.

The dust box 70 includes a box body 71 and a lid 73. The box body 71 is a deep box having an opening rearward. The lid 73 is a vertically long rectangle, and is connected to a portion below the opening of the box body 71 with a hinge shaft 72 in a rotatable manner. The lid 73 has an engagement tab 74 on its upper end. The engagement tab 74 is a loop that engages with the upper surface of the box body 71 in a closed state of the opening of the box body 71 and maintains the closed state. The lid 73 has a rectangular inlet 75 extending laterally on its upper end. The inlet 75 receives the lower end portion of the duct 63 when the lid 73 is attached to the connecting portion 47. The lid 73 has a circular outlet 76 on its lower end. The outlet 76 faces the communication hole 49 when the lid 73 is attached to the connecting portion 47.

A filter compartment 77 is located in front of the outlet 76 of the lid 73. The filter compartment 77 holds a paper filter 78 folded laterally with vertical folds. In this state, the tops of the vertical folds of the filter 78 are exposed at equal intervals in the lateral direction. The right and left sides of the filter 78 are also exposed inside the box body 71.

The lower surface of the box body 71 has a groove 79 to fit with the receiving shaft 65 for the connecting portion 47. An operation tab 80 is located on the upper surface of the box body 71 to elastically engage with the engagement protrusion 66 on the connecting portion 47. A dust removal knob 81 is located on a front lower surface of the box body 71. The dust removal knob 81 is rotated to vibrate the box body 71 to remove accumulating dust off the filter 78.

The dust box 70 is placed, with the lid 73 rearward, to have an inclined posture with the groove 79 fitted with the receiving shaft 65 from the front. The dust box 70 is then pressed into the connecting portion 47 to be raised upright. The operation tab 80 thus elastically engages with the engagement protrusion 66 to allow attachment to the connecting portion 47. In the attached state, the duct 63 has its distal end fitted with the inlet 75 to protrude into the box body 71. The outlet 76 thus faces the communication hole 49 and communicates with the air inlet chamber 46. The dust collection attachment 40 defines an internal dust collection path R for sucking air through the suction port 61 and through the nozzle 60, the flexible hose 62, the duct 63, and the filter 78 in the box body 71 to the air inlet chamber 46.

In the dust collection system S according to the present embodiment, the dust collection attachment 40 is attached to the hammer drill 1 by first aligning the guide grooves on the attachment portion 30 with the guide rails on the casing 41 to place the attachment portion 30 above the rear portion of the casing 41. The dust collection attachment 40 is then slid rearward to fit the casing 41 with the attachment portion 30 from the front. Thus, the guide rails are fitted into the right and left guide grooves on the attachment portion 30 for connecting the attachment portion 30 with the guide rails. The upward pressing member 56 enters the lower recess 35 and presses the pressing bar 34 upward. This moves the shutter 33 upward to swing the female connector 31 to the uppermost position facing the insertion opening 32. The dust collection attachment 40 thus allows the male terminals of the male connector 51 to enter the housing 2 through the insertion opening 32. The male terminals are thus electrically connected to the female terminals of the female connector 31.

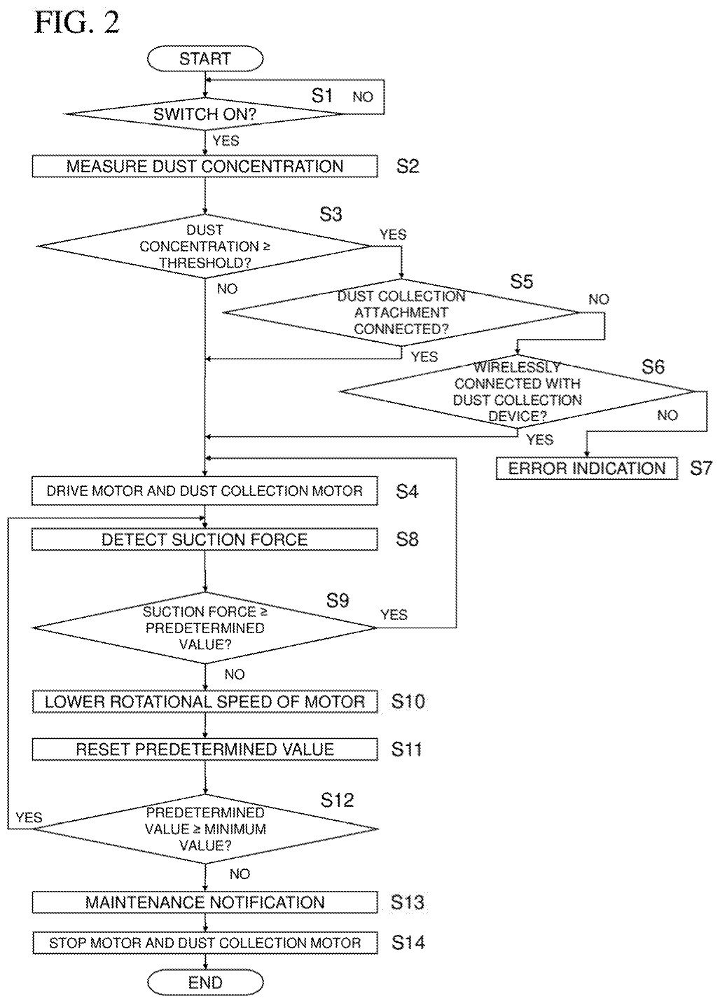

To operate the hammer drill 1, the suction port 61 is placed to abut against a target surface of a workpiece, and the switch lever 20 is pressed. The controller 24 measures the dust concentration in the work environment using an external dust concentration meter, and controls the operation of the dust collection system S in accordance with the measured value. The operation control will now be described with reference to a flowchart shown in FIG. 2. A dust collection apparatus may herein collectively refer to the dust collection attachment and an external dust collection device without distinguishing them from each other.

In S1, the switch lever 20 is pressed to turn on the switch 19. In S2, the controller 24 detecting the operation measures the dust concentration in the work environment through the wireless unit 25 using an external dust concentration meter that may be hung at the work site or carried by a worker.

Subsequently, in S3, the controller 24 determines whether the measured dust concentration is greater than or equal to a predetermined threshold. When the measured concentration is less than the threshold, the controller 24 drives the motor 3 (S4).

When the measured concentration is greater than or equal to the threshold, the controller 24 determines whether the dust collection attachment 40 is connected (S5). When the dust collection attachment 40 is determined to be connected, the controller 24 drives the motor 3 (S4). At the same time, the dust collection attachment 40 drives the dust collection motor 42.

When determining that the dust collection attachment 40 is not connected in S5, the controller 24 determines whether wireless cooperation is enabled with an external dust collection device through the wireless unit 25 (S6). When such cooperation with an external dust collection device is detected, the controller 24 drives the motor 3 and the dust collection motor in the dust collection device (S4). When such cooperation with the dust collection device is not detected, the controller 24 generates an error indication without driving the motor 3 (S7). The indication uses, for example, flashing of a light-emitting diode (LED) on an outer surface of the wireless unit 25 or an electronic sound or a buzzer sound.

The controller 24 drives the motor 3 when the dust concentration is less than the threshold, or when the dust collection apparatus is connected and the dust concentration is greater than or equal to the threshold. In other words, when the hammer drill 1 is used alone, the controller 24 does not drive the motor 3 when the dust concentration is greater than or equal to the threshold.

The threshold is determined in accordance with, for example, the permissible exposure limit (PEL) defined by the Occupational Safety and Health Administration (OSHA), which is one of the federal agencies under the United States Department of Labor (DOL). The PEL for respirable crystalline silica in air is set to a concentration of 50 μg/m³ as an eight-hour time-weighted average. The above value may be used as a reference in determining the threshold.

When the motor 3 is driven, the countershaft 6 rotates. A switching knob (not shown) on a side surface of the housing 2 is operated to slide the clutch 8 for selecting a drill mode, a hammer mode, or a hammer drill mode. In the drill mode, the clutch 8 is at a frontward position to mesh with the first gear 7 alone. In the hammer mode, the clutch 8 is at a rearward position to mesh with the boss sleeve 9 alone. In the hammer drill mode, the clutch 8 is at a middle position to mesh with both the first gear 7 and the boss sleeve 9 at the same time.

In the drill mode, the tool holder 10 is rotated with the second gear 17 to rotate the bit B. In the hammer mode, the arm 13 swings to reciprocate the piston cylinder 11. The striker 15 is operated through the air chamber 14 in cooperation with the piston cylinder 11, and strikes the bit B with the impact bolt 16. In the hammer drill mode, the tool holder 10 rotates and the impact bolt 16 is struck at the same time. With the suction port 61 positioned for operation, the hammer drill 1 is moved forward to move the nozzle 60 and the slide cylinder 59 rearward. The bit B thus passes through the suction port 61 and machines the workpiece.

When the motor 3 is driven in S4, the dust collection motor 42 is also driven to rotate the dust collection fan 45. This sucks the outside air through the suction port 61, which then passes through the nozzle 60, the dust collection path R, and the air inlet chamber 46 and is discharged outside through the air outlet. Thus, dust from the workpiece is sucked through the suction port 61, enters the dust box 70 through the nozzle 60, the flexible hose 62, and the duct 63, and passes through the filter compartment 77 and is caught by the filter 78 and stored in the box body 71.

In S8, the controller 24 detects the suction force of the dust collection attachment 40 based on a detection signal from the pressure sensor 50. In S9, the controller 24 determines whether the detected suction force is greater than or equal to a predetermined value. For a dust collection device, an output signal from the dust collection device is detected and compared with a predetermined value.

When the suction force is greater than or equal to the predetermined value, the motor 3 and the dust collection motor continue to be driven. When the suction force is less than the predetermined value, the controller 24 lowers the rotational speed of the motor 3 (S10). The controller 24 then resets the predetermined value to a lower value than the predetermined value used in S8 (S11).

In S12, the controller 24 determines whether the reset predetermined value is greater than or equal to the minimum value of the suction force. When the predetermined value is greater than or equal to the minimum value, the motor 3 continues to be driven. When the predetermined value is determined to be less than the minimum value in S12, the controller 24 performs a maintenance notification by, for example, flashing an LED in S13, and stops driving the motor 3 in S14. At the same time, the controller 24 transmits a stop command to the dust collection apparatus to stop the dust collection motor. The dust collection controller 44 stops the dust collection motor 42 after a predetermined duration in response to the stop command to remove the residual dust in, for example, the flexible hose 62.

After the dust collection system S stops operating, the operator slides the dust collection attachment 40 forward to detach it from the hammer drill 1 with the procedure reverse to the attachment of the dust collection attachment 40. In the dust collection attachment 40, the operation tab 80 is pressed down and disengaged from the engagement protrusion 66, and the dust box 70 is rotated about the receiving shaft 65 to have its upper portion pulled down forward, and is thus detached from the connecting portion 47. The engagement tab 74 on the lid 73 is disengaged from the box body 71 to open the lid 73, and dust can be discarded from the box body 71 through the opening of the box body 71. To discard dust, the dust box 70 alone may be detached without detaching the dust collection attachment 40 from the hammer drill 1. The filter 78 may be changed as appropriate. The suction force is thus restored to allow use of the dust collection system S. To restore the suction force, the dust removal knob 81 may be operated to remove dust from the filter 78, instead of discarding dust. For the dust collection device as well, the filter may be cleaned or changed.

The hammer drill 1 according to the first embodiment includes the controller 24 (control unit) that controls an operation when the dust concentration obtained from an external unit is greater than or equal to a predetermined threshold. Thus, the hammer drill 1 alone may be used to prevent the dust concentration from increasing with dust scattering in the work environment (particularly indoor environment). This enables the operation in accordance with each work environment.

In particular, the controller 24 allows the hammer drill 1 connected to the dust collection apparatus to operate when the dust concentration is greater than or equal to the threshold. The dust collection apparatus can collect dust from work in a more reliable manner, and prevents the dust concentration from increasing further and also allows the work to be continued.

The controller 24 allows the hammer drill 1 to operate when the suction force of the dust collection apparatus is greater than or equal to the predetermined value. This eliminates the likelihood that the work is continued with the dust collection apparatus having a low suction force being connected.

The controller 24 obtains the dust concentration from the external dust concentration meter. The dust concentration in the work environment can be measured accurately.

The dust collection system S according to the first embodiment includes the controller 24 (system control unit) for controlling the system. The controller 24 obtains the dust concentration from an external unit, and controls the operation of the hammer drill 1 and the operation of the dust collection apparatus in accordance with the obtained dust concentration. This structure can regulate, for example, the operation of the system when the work environment has a high dust concentration, thus enabling the operation in accordance with each work environment.

In particular, the controller 24 regulates the operation of the hammer drill 1 when the obtained dust concentration is greater than or equal to the predetermined threshold. The controller 24 allows the hammer drill 1 to operate under the dust concentration greater than or equal to the threshold when the dust collection apparatus has a suction force greater than or equal to the predetermined value. The dust collection apparatus can collect dust from work in a more reliable manner, and prevents the dust concentration from increasing further and also allows the work to be continued.

The controller 24 lowers the rotational speed of the motor 3 of the hammer drill 1 when the dust collection apparatus has a suction force less than the predetermined value during the operation of the hammer drill 1. Thus, the hammer drill 1 is used continuously without its operation being regulated immediately after the suction force decreases. This prevents the work efficiency from being degraded by discontinued work.

### Second Embodiment

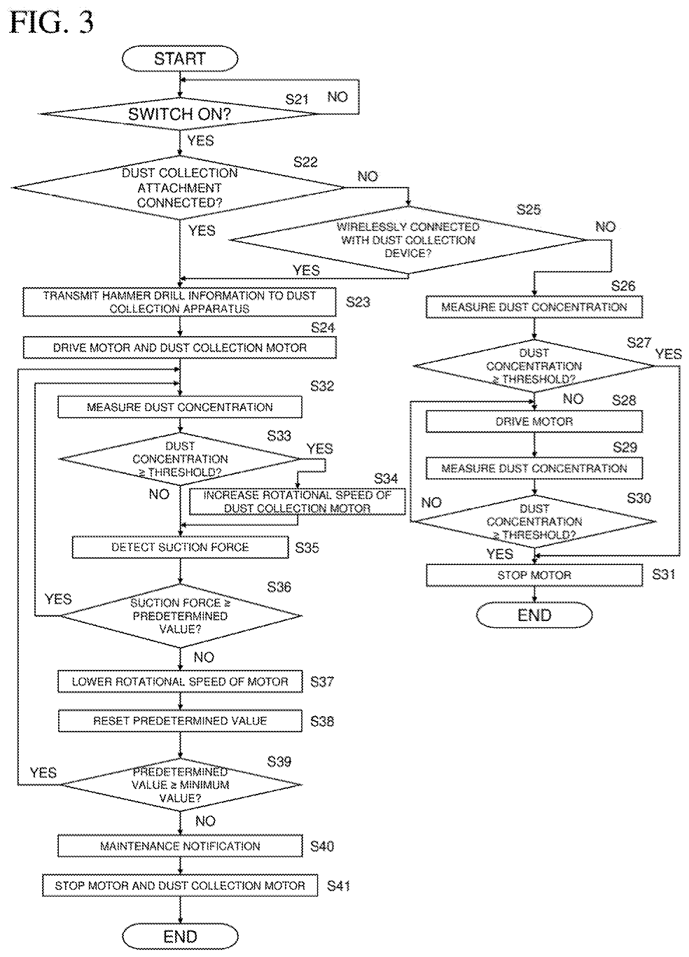

In the first embodiment, the dust concentration is measured first when the switch is turned on, and then the determination is performed on whether the dust collection apparatus is connected when the dust concentration is greater than or equal to the threshold. In the present embodiment, the determination may be performed on whether the dust collection apparatus is connected first when the switch is turned on, and then the operation of the hammer drill may be controlled in accordance with the state of the dust collection apparatus or the dust concentration. In the present embodiment, the control over the dust collection system S will be described with reference to the flowchart in FIG. 3, and the hammer drill 1 and the dust collection attachment 40 each having the same structure as in the first embodiment will not be described.

In S21, the switch lever 20 is pressed to turn on the switch 19. In S22, the determination is performed on whether the dust collection attachment 40 is connected. When the dust collection attachment 40 is determined to be connected, the controller 24 transmits information about the hammer drill 1 (e.g., the type, size, and performance) to the dust collection controller 44 in S23.

Subsequently, in S24, the controller 24 drives the motor 3. Also, the dust collection controller 44 drives the dust collection motor 42 at a predetermined rotational speed based on the information received from the controller 24.

When the dust collection attachment 40 is determined to be disconnected in S22, the determination is performed on whether wireless cooperation is enabled with an external dust collection device (S25). When wireless cooperation is detected, the controller 24 transmits information about the hammer drill 1 to the dust collection controller 44 in the dust collection device (S23), and drives the motor 3 (S24). At the same time, the dust collection controller 44 in the dust collection device drives the dust collection motor at a predetermined rotational speed based on the information received from the controller 24.

When no wireless cooperation with an external dust collection device is detected in S25, the hammer drill 1 is operated alone, and the dust concentration is measured (S26). In S27, the determination is performed on whether the measured dust concentration is greater than or equal to the threshold. When the measured dust concentration is less than the threshold, the motor 3 is driven to enable use of the hammer drill 1 alone (S28). During operation, the dust concentration is obtained continuously (S29), and the determination is performed on whether the dust concentration is greater than or equal to the threshold (S30). When the dust concentration is greater than or equal to the threshold, the motor 3 stops being driven (S31). Similarly, when the dust concentration is greater than or equal to the threshold in S27, the motor 3 is not allowed to be driven (S31).

When the hammer drill 1 and the dust collection apparatus operate at the same time in S24, the dust concentration is also measured (S32). In S33, the determination is performed on whether the measured dust concentration is greater than or equal to the threshold. When the measured dust concentration is determined to be greater than or equal to the threshold, the dust collection motor in the dust collection apparatus increases the rotational speed (S34). This increases the suction force, allowing the work to be continued when the dust concentration rises.

Subsequently, the suction force of the dust collection apparatus is detected (S35), and the determination is performed on whether the detected suction force is greater than or equal to the predetermined value in S36. When the suction force is greater than or equal to the predetermined value, the processing returns to S32 to continue the operation, where the dust concentration is measured. When the amount of stored dust increases, and the suction force is determined to decrease below the predetermined value in S36, the rotational speed of the motor 3 is lowered to reduce dust (S37). The predetermined value for the suction force is then reset to a lower value (S38).

In S39, the determination is performed on whether the reset predetermined value is greater than or equal to the minimum value of the suction force under which dust is collectable. When the predetermined value is greater than or equal to the minimum value, the processing returns to S32 to continue the operation. When the predetermined value is less than the minimum value, maintenance notification is performed in S40, and the motor 3 and the dust collection motor stop in S41.

The dust collection system S according to the present embodiment includes the controller 24 for controlling the operation of the hammer drill 1 in accordance with the state of the dust collection apparatus. This enables the work in accordance with the dust collection function, thus enabling the operation in accordance with each situation of work.

The operation of the dust collection apparatus is controlled in accordance with the type of the hammer drill 1. This enables the dust collection apparatus to operate optimally for the type of the hammer drill 1.

In each embodiment, the dust concentration meter may not be located externally to the system, but may be mounted on the hammer drill, the dust collection attachment, or an external dust collection device.

Also, two (or three or more) thresholds for high and low dust concentrations may be set to allow the hammer drill to be used alone under a low dust concentration without determining whether the dust collection apparatus is connected, or to regulate the operation of the hammer drill under a high dust concentration when the dust collection apparatus is determined to be disconnected. When the dust concentration is greater than or equal to the threshold, an indication may be generated instead of the operation being regulated or the rotational speed of the dust collection motor being increased.

When the suction force of the dust collection apparatus decreases below the predetermined value, the predetermined value may be reset without lowering the rotational speed of the hammer drill, or maintenance notification may be performed without resetting the predetermined value. A detection unit for detecting the amount of stored dust, such as a sensor, may be used instead of the pressure sensor for a suction force to allow the operation of the hammer drill or to lower the rotational speed of the motor when the amount of dust is smaller than or equal to a predetermined value. A flow rate (blow speed) may be detected.

In some embodiments, the hammer drill may include a motor oriented differently or a motor of a different type or battery packs arranged differently as appropriate. The hammer drill may be powered by alternating current (AC) and may include a power cord, instead of battery packs. The dust collection attachment may also have any structure for connection to the hammer drill, any arrangement of the dust box, and any structure for connection to the casing other than those described in the above embodiments.

An apparatus for regulating the operation of a power tool in accordance with the dust concentration according to embodiments of the present invention may not be the dust collection attachment including the dust collection motor and the dust collection fan, but simply include the dust box and may generate a suction force using a fan connected to a motor in the power tool. In this case, the motor in the power tool alone is controlled in S4 and S14 in FIG. 2, and in S24, S34, and S41 in FIG. 3.

The present invention is applicable not only to a hammer drill but also to other power tools connectable to a dust collection apparatus, such as an electric drill and an electric hammer.

### REFERENCE SIGNS LIST

1 hammer drill
2 housing
3 motor
4, 43 output shaft
6 countershaft
10 tool holder
19 switch
20 switch lever
24 controller
25 wireless unit
30 attachment portion
40 dust collection attachment
41 casing
42 dust collection motor
44 dust collection controller
45 dust collection fan
46 air inlet chamber
47 connecting portion
49 communication hole
50 pressure sensor
59 slide cylinder
60 nozzle
61 suction port
62 flexible hose
70 dust box
71 box body
73 lid
77 filter compartment
78 filter
S dust collection system
B bit
R dust collection path

What is claimed is:

1. A power tool, comprising:
a control unit configured to control an operation, and regulate the operation when a dust concentration obtained from an external unit is greater than or equal to a predetermined threshold.

2. The power tool according to claim 1, wherein
the control unit allows the operation when the dust concentration is greater than or equal to the threshold and a dust collection apparatus is connected to the power tool.

3. The power tool according to claim 2, wherein
the control unit allows the operation when the dust collection apparatus has a suction force greater than or equal to a predetermined value.

4. The power tool according to claim 1, wherein
the control unit obtains the dust concentration from an external dust concentration meter.

5. The power tool according to claim 2, wherein
the control unit obtains the dust concentration from an external dust concentration meter.

6. The power tool according to claim 3, wherein
the control unit obtains the dust concentration from an external dust concentration meter.

7. A dust collection system for a power tool, the system comprising:
a power tool;
a dust collection apparatus connected to the power tool; and
a system control unit configured to control an operation of the system, and control an operation of the power tool and/or an operation of the dust collection apparatus in accordance with a dust concentration obtained from an external unit.

8. The dust collection system according to claim 7, wherein
the system control unit regulates the operation of the power tool when the dust concentration is greater than or equal to a predetermined threshold, and
allows the operation of the power tool when the dust concentration is greater than or equal to the threshold and the dust collection apparatus has a suction force greater than or equal to a predetermined value.

9. The dust collection system according to claim 7, wherein
the system control unit reduces an output of the power tool when a suction force of the dust collection apparatus decreases below a predetermined value during the operation of the power tool.

10. The dust collection system according to claim 8, wherein
the system control unit stops the power tool when the predetermined value is less than a minimum value of the suction force under which dust is collectable.

11. The dust collection system according to claim 7, wherein
the system control unit controls the operation of the dust collection apparatus in accordance with a type of the power tool.

12. The dust collection system according to claim 7, wherein
the system control unit obtains the dust concentration from an external dust concentration meter.

13. The dust collection system according to claim 8, wherein
the system control unit reduces an output of the power tool when a suction force of the dust collection apparatus decreases below a predetermined value during the operation of the power tool.

14. The dust collection system according to claim 9, wherein
the system control unit stops the power tool when the predetermined value is less than a minimum value of the suction force under which dust is collectable.

15. The dust collection system according to claim 8, wherein
the system control unit controls the operation of the dust collection apparatus in accordance with a type of the power tool.

16. The dust collection system according to claim 9, wherein
the system control unit controls the operation of the dust collection apparatus in accordance with a type of the power tool.

17. The dust collection system according to claim 10, wherein
the system control unit controls the operation of the dust collection apparatus in accordance with a type of the power tool.

18. A dust collection system for a power tool, the system comprising:
a power tool;
a dust collection apparatus connected to the power tool; and
a system control unit configured to control an operation of the system, and control an operation of the power tool in accordance with a state of the dust collection apparatus.
